(19) United States
(12) Patent Application Publication
(10) Pub. No.: US 2009/0033659 A1
(43) Pub. Date: Feb. 5, 2009

(54) Real-time luminosity dependent subdivision

(76) Inventors: Adam T. Lake, Portland, OR (US); Rahul P. Sathe, Hillsboro, OR (US); David J. Bookout, Portland, OR (US)

Correspondence Address: TROP PRUNER & HU, PC, 1616 S. VOSS ROAD, SUITE 750, HOUSTON, TX, 77057-2631, US

(21) Appl. No.: 11/888,158

(22) Filed: Jul. 31, 2007

(51) Int. Cl. G06T 15/30

(52) U.S. Cl. 345/423

(57) ABSTRACT

In one embodiment, the present invention includes a method for receiving geometry data corresponding to a plurality of polygons of a scene, calculating a luminosity metric for each polygon, and subdividing a polygon into multiple polygons if the luminosity metric is greater than a threshold level. Other embodiments are described and claimed.

### BACKGROUND

In modern graphics processing, a common technique to provide greater detail is to subdivide each polygon of a scene into multiple polygons to improve resolution. Typical subdivision algorithms work on a per model or per scene basis to subdivide the entire model to a given level of subdivision. The result is too much subdivision in areas that are not even lit. Some systems use a static level of detail (LOD) switch to change levels of subdivision that is dependent on distance from a camera. Objects closer to the camera use a static level of detail that represents the geometry to a desired level of quality. However, a significant amount of geometry needs to be sent from a processor such as a central processing unit (CPU) to a graphics processor (e.g., a graphics processing unit (GPU)). For example, current LOD techniques use 3-5 static levels of detail meshes. However, this does not put polygons where they matter most, and such algorithms do not take into account scene dependent attributes like whether the object is lit, behind another object, and so forth.

### BRIEF DESCRIPTION OF THE DRAWINGS

FIG. 1 is a flow diagram of a method in accordance with one embodiment of the present invention.

FIG. 2 is a graphical representation of a resulting scene generated in accordance with one embodiment of the present invention.

FIG. 3 is a block diagram of a system in accordance with one embodiment of the present invention.

### DETAILED DESCRIPTION

In various embodiments, view dependent subdivision may be performed in a graphics pipeline. In this way, embodiments may take advantage of hardware features such as a geometry shader and streamout capabilities to implement subdivision. More specifically, embodiments may perform a scene-by-scene frame dependent algorithm to allow optimal allocation of bandwidth and compute resources so geometry is placed in the scene where it has the most benefit to the visual result. This stands in contrast to a subdivision kernel that is implemented on a per model basis. To reduce bandwidth further, embodiments do not subdivide geometry that is hidden behind other geometry, not facing the screen, or geometry that is in a hard shadow. In areas of soft shadow, translucency, or in fog, subdivision may still be performed, but to a lower scene and context dependent resolution. The end result is putting polygons where they matter most. Embodiments may also exploit the fact that a bandwidth limited architecture may exist (i.e., the bottleneck is the memory hierarchy, not the execution resources), therefore execution bandwidth may be traded to reduce the memory bandwidth to a graphics memory.

Amongst other things, the visual fidelity of any object in a final image is proportional to the number of faces of that object that get rendered. Subdivision of surfaces allows one to control this number of faces dynamically without increasing the memory bandwidth requirements. In the virtual worlds, there are many factors that affect the number of rays (or in other words—intensity of rays) bouncing off an object and reaching a viewer's eyes. These rays and the energy they carry with them to the viewer's eye is what makes a particular object more clearly visible than others. If more energy reaches the viewer's eyes after bouncing off the surface of an object, then one expects that portion of the object's surface to be more clearly visible and thus needs more faces to represent that portion of the object's surface. Subdivision of surfaces can be used to tweak the tessellation in such cases.

In some embodiments, an algorithm for dynamically controlling subdivision of polygons may be based on a set of equations linking a metric of realism with a number of faces of the polygons. Specifically, an algorithm may be executed in accordance with Equations 1.1-1.4 following:

Realism=F(Energy reaching viewer's eyes) [EQ. 1.1]

Realism=k*Number of faces used to represent the object's surface [EQ. 1.2]

where k is a constant, and which may correspond to an arbitrary number.

Number of Faces=constant*Degree of subdivision [EQ. 1.3]

From EQs. 1.1, 1.2 and 1.3, one can deduce

Degree of Subdivision=K*F(Energy reaching viewer's eyes), where K=1/(k*constant) [EQ. 1.4]

Energy reaching a viewer's eyes is a function of many parameters, some scene dependent e.g., shadows, transparency of objects along the way to viewer, distance of object from viewer and some scene independent parameters like fog, ambient light, etc.

Dynamic parameters make it very difficult to employ static approaches like level of detail (LOD), where a programmer simply renders higher or lower resolution models. Many parameters like shadows are not only not known before rendering but are not constant throughout the scene. In other words, objects that are in shadows do not transfer as much energy as the ones that are brightly lit. Things like shadows cast on parts of objects, or objects being partially occluded by semi-transparent objects make it necessary to render some parts of objects with higher resolution of meshes than others.

Embodiments yield themselves very well for such kinds of dynamic decisions with regard to degree of subdivision. Embodiments can work at the polygon-level granularity instead of at the object-level granularity. Thus in one instance, Equation 1.4 can be expressed for a given polygon as:

Subdivision Degree=G(Shadow, Semi-transparent objects, Fog, Distance from viewer, Distance from the point light) [EQ. 1.5]

where G is a function that returns an integer from 0 to a ‘maximum level of subdivision.’ In some embodiments, this maximum may be 4 or 5.

Using embodiments of the present invention to provide run-time subdivision of surfaces may provide a number of advantages. For example, embodiments may provide for low memory bandwidth requirements and low memory footprint. Further, the decision to subdivide can be dynamically made on a per-triangle basis, and results that are generated at render time can be used to control the subdivision. In this way, embodiments may be GPU-centric and take full advantage of next generation programmable graphics hardware, and allow multiple levels of subdivision to be chosen for one object.

Accordingly, a rendered mesh may be generated that has more polygons being rendered in lighter areas and less polygons rendered in areas in shadow. Thus a luminosity dependent subdivision mesh may be formed. Compared to a conventional subdivision implementation, a far fewer amount of polygons may be rendered to provide the same level of resolution for a completed image.

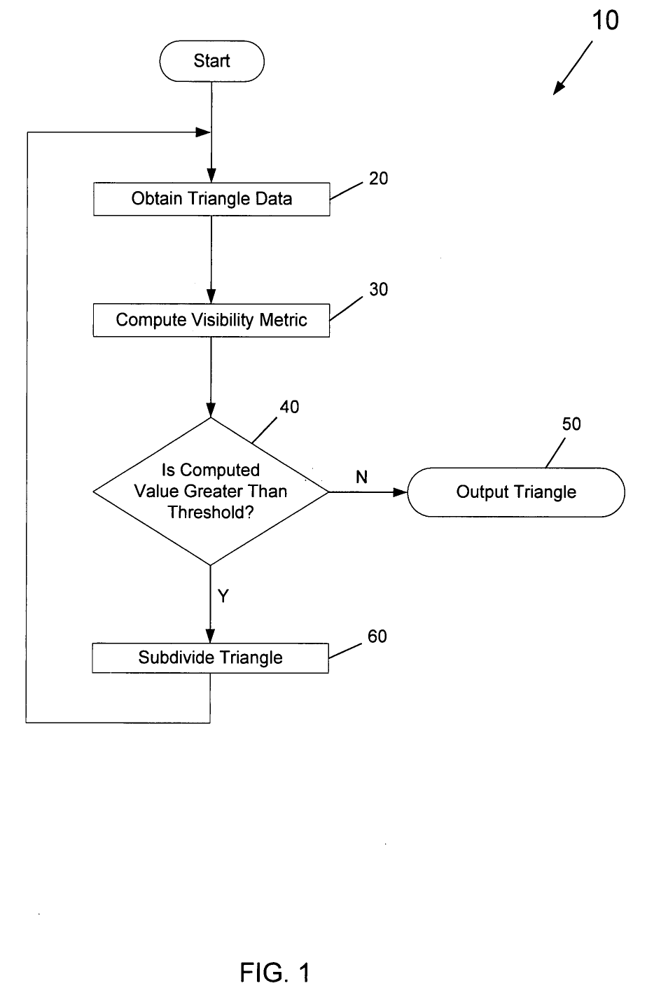

Referring now to FIG. 1, shown is a flow diagram of a method in accordance with one embodiment of the present invention. As shown in FIG. 1, method 10 may be performed in a graphics pipeline, e.g., during rendering of polygon data into meshes, and in some embodiments, method 10 may be performed in a geometry shader. As shown in FIG. 1, method 10 may begin by obtaining triangle data (block 20). While described with regard to FIG. 1 as being performed on triangle data, understand the scope of the present invention is not limited in this regard, and polygons of many different shapes may be subdivided and rendered in accordance with this embodiment. For example, such triangle data may be obtained from a main processor such as a CPU and stored in a graphics memory. The received triangle data, which may be received, e.g., in a graphics pipeline, may be used to compute a visibility metric (block 30). While the scope of the present invention is not limited in this regard, in some embodiments a visibility metric may be computed in accordance with Equations 1.1-1.5, described above. Next, it may be determined at diamond 40 whether the computed value for a given polygon is greater than a threshold. While the scope of the present invention is not limited in this regard, in some embodiments the threshold may be an integer value.

If it is determined that the computed value is not greater than the threshold, control passes to block 50, where the triangle data may be output, e.g., to a render engine, with no further subdivision. Accordingly, various processing steps may be performed to render a mesh including the given triangle. If instead at diamond 40 the computed value is greater than the threshold, control passes to block 60 where the triangle may be subdivided. After subdivision, e.g., into two triangles, for the data of each triangle, control may pass back to block 20 for further processing of the subdivided triangle data. While shown with this particular implementation in the embodiment of FIG. 1, the scope of the present invention is not limited in this regard.

Accordingly, various embodiments may exploit luminosity dependence or the fact that polygons behind transparent objects will need lower levels of subdivision to reduce bandwidth while providing a sufficient level of subdivision of higher luminosity areas. Additionally, embodiments may take into account atmospheric effects such as fog or other conditions.

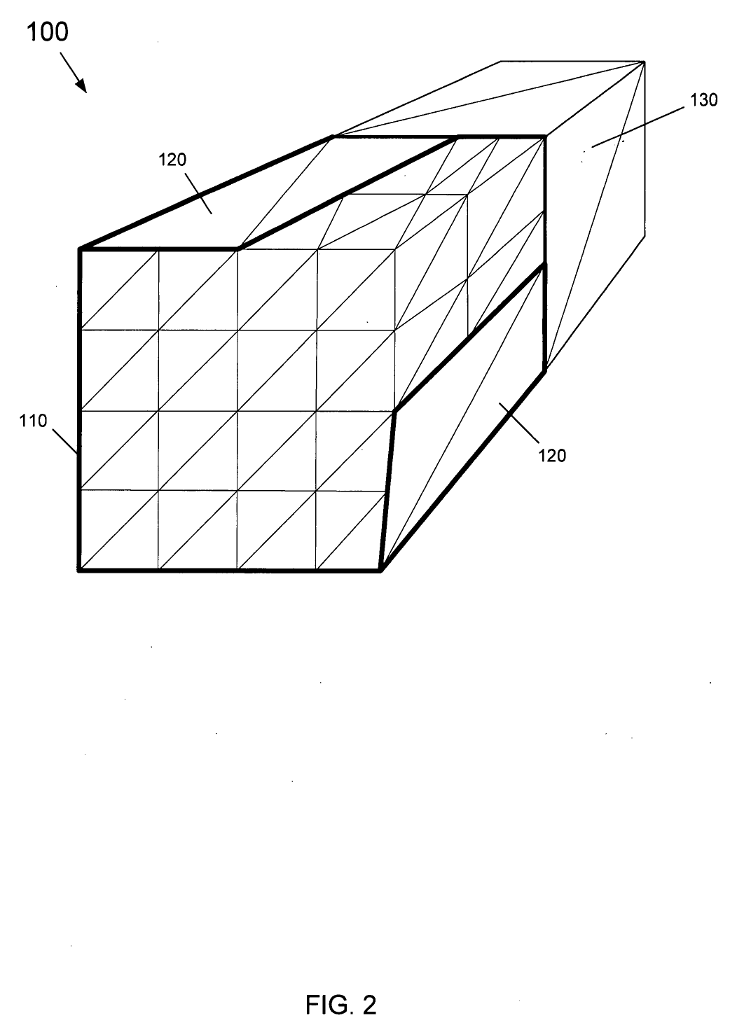

Referring now to FIG. 2, shown is a graphical representation of an object 100 rendered in accordance with an embodiment of the present invention. As shown in FIG. 2, object 100, which may be an object of a scene includes different regions having different luminosities. Specifically, as shown in FIG. 2, object 100 includes a first region 110 that has a maximum number of rays (i.e., energy) bouncing off it to an eye point. Accordingly, as shown in FIG. 2, region 110 has a large amount of polygons representing multiple subdivisions of the polygon data of region 110. Also shown in FIG. 2 is a second region 120 that has a lesser amount of rays that is provided to a viewer's eye. Accordingly, a lesser amount of subdivision is performed in region 120. Still further, a third region 130 has a smallest amount of energy that reaches a viewer's eye. Accordingly, a minimal amount of subdivision may be performed in region 130. While shown with this particular implementation in the embodiment of FIG. 2, the scope of the present invention is not limited in this regard.

Referring now to Table 1, shown are examples of the net percentage of savings that may be realized with regard to the total number of polygons rendered using an embodiment of the present invention and a conventional polygon rendering operation. As shown in Table 1, using embodiments of the present invention savings of greater than 88% and all the way up to greater than 99% may be realized.

TABLE 1

| | | | |
|---|---|---|---|
| Polygons in standard subdivided scene | 1,000,000 | 1,000,000 | 1,000,000 |
| Number of lights casting shadow volumes | 1 | 4 | 16 |
| % of back facing polygons | 50% | 50% | 50% |
| % of polygons in shadow | 50% | 60% | 70% |
| % of polygons translucent | 20% | 20% | 20% |
| % of polygons hidden behind fog | 10% | 10% | 10% |
| Total number of polygons with view | 5000 | 24000 | 112000 |
| dependent subdivision | | | |
| Number of polygons rendered without view | 1,000,000 | 1,000,000 | 1,000,000 |
| dependent subdivision | | | |
| saved with luminosity dependent subdivision | 99.5 | 97.6 | 88.8 |

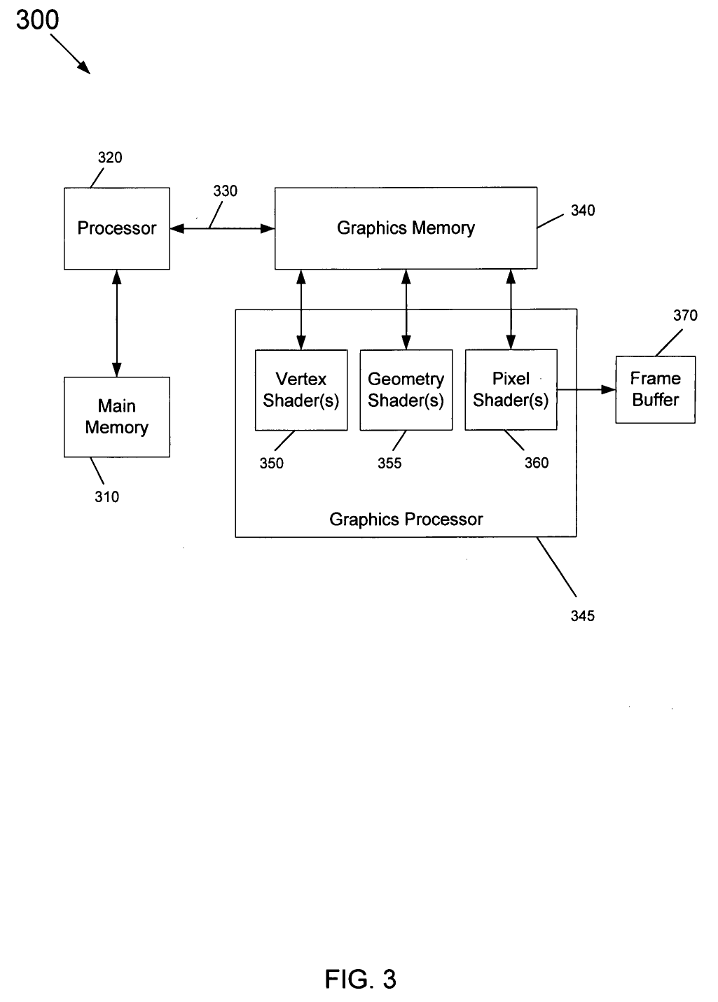

FIG. 3 illustrates an example system 300 in which embodiments may be implemented. System 300 may include a main memory 310, a processor 320, a data bus 330, a graphics memory 340, a graphics processor 345, which may include one or more vertex shaders 350, one or more geometry shaders 355, and one or more pixel shaders 360 in addition to other pipeline components such as other render engines and so forth, and a frame buffer 370. In some implementations, one or more of elements 340-370 may be included in a physically distinct graphics processor or card that is connected to processor 320 via data bus 330, although the scope of the present invention is not limited in this regard. In other embodiments, processor 320 may include the graphics processing components.

Main memory 310 may include a storage device to store geometry data, such as a random access memory (RAM), e.g., a dynamic RAM (DRAM). Main memory 310 may store pre-computed geometry and/or graphical data from which to compute geometry. Processor 320 may be a general-purpose processor, a specific-purpose processor, and/or logic configured for a specific purpose. Processor 320 may be arranged to distribute geometry data from main memory 310 to graphics memory 340 via data bus 330. Processor 320 may send the geometry data via data bus 330 under control of a program, such as a rendering, game, graphical creation, or other type of graphics-related program. Data bus 330 may connect processor 320 to graphics memory 340. Data bus 330 may have an associated bandwidth that defines a maximum amount of data that it can transfer in a given time. In some implementations, the bandwidth of data bus 330 may limit the performance of other portions of system 300 (e.g., shaders 350 and/or 360).

Graphics memory 340 may include a storage device to store geometry data. Graphics memory 340 may include a random access memory (RAM), such as a DRAM. Graphics memory 340 may receive and store geometry data from processor 320 and vertex shaders 350. In addition to storing geometry data via write operations, graphics memory 340 may provide such geometry data to vertex shaders 350, geometry shaders 355, and pixel shaders 360 via read operations. For example, graphics memory 340 may store various “per-vertex” data associated with the geometry data. Such vertex data may include one or more of vertex positions, texture coordinates, color coordinates, or normal vectors.

Geometry shaders 355 may be arranged to read the polygon data from graphics memory 340 and to subdivide the polygon data to generate higher-resolution vertex data in accordance with an embodiment of the present invention. Vertex shaders 350 may have a parallel architecture, and may have a larger instruction set than, for example, pixel shaders 360. Geometry shaders 355 may use various geometry generation programs and subdivision schemes to increase the resolution of the geometry data. For example, graphics processor 345, e.g., using geometry shaders 355, may implement a luminosity-based subdivision method such as described herein to provide vertex data of different levels of detail for different regions of an object. Geometry shaders 355 may receive as input data triangle/polygon data and, optionally, neighbor data. To perform sub-division in accordance with an embodiment of the present invention, geometry shaders 355 may process the incoming data in a multi-stage pipeline including various stages such as an input stage, a vertex shader stage, a geometry shader stage, a rasterizer stage (note that in some embodiments a stream output stage may provide output data from the geometry shader stage), a pixel shader stage, and an output/merger stage. In some implementations the pixel shader stage may receive data from memory for processing with the rasterized output from the rasterizer stage. Of course a geometry shader may take different forms in other embodiments.

Geometry shaders 355 may create new vertices and polygon connectivity information using a subdivision scheme. Typical subdivision schemes may increase the amount of data in a mesh by a factor of four. Thus geometry shaders 355 may be arranged to perform one or more levels of subdivision for a given mesh, and once-subdivided, the data stored in graphics memory 340, for example, may be used by geometry shaders 355 to generate a second level of subdivided data (e.g., at a higher/finer resolution) for storage in graphics memory 340.

Pixel shaders 360 may be arranged to read the subdivided geometry data from graphics memory 340 and prepare it for display. In some implementations, pixel shaders 360 may rasterize the new mesh images using the lower-resolution geometry data from processor 320 (which may remain in graphics memory 340) as display primitives. Frame buffer 370 may be arranged to receive pixel data from pixel shaders 360 and buffer it, if necessary, prior to display. Frame buffer 370 may also output data to a display or display interface (not shown).

Embodiments may be implemented in code and may be stored on a storage medium having stored thereon instructions which can be used to program a system to perform the instructions. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
receiving geometry data corresponding to a plurality of polygons of a scene to be rendered into a mesh;
for each polygon, calculating a luminosity metric and comparing the luminosity metric to a predetermined threshold; and
subdividing the polygon into a plurality of subdivided polygons if the luminosity metric is greater than the predetermined threshold, otherwise not subdividing the polygon and outputting the geometry data for the polygon to a render engine.

2. The method of claim 1, further comprising calculating the luminosity metric and comparing the luminosity metric to the predetermined threshold for each of the plurality of subdivided polygons, and further subdividing each of the plurality of subdivided polygons if the corresponding luminosity metric is greater than the predetermined threshold.

3. The method of claim 1, further comprising preventing subdivision of a polygon if the polygon is in a shadow region of the scene.

4. The method of claim 3, further comprising preventing subdivision of a polygon if the polygon is back facing, translucent, or hidden behind fog.

5. The method of claim 1, further comprising dynamically determining a level of subdivision for each of the plurality of polygons greater than the predetermined threshold based on the luminosity metric.

6. The method of claim 5, further comprising dynamically determining different levels of subdivision for each of the plurality of polygons of a single object.

7. The method of claim 1, wherein the luminosity metric is based on a realism value corresponding to an intensity of rays emanating from the polygon to a viewer and a number of faces used to represent a surface of an object in the scene.

8. The method of claim 1, further comprising receiving the geometry data from a first processor and calculating the luminosity metric in a second processor, the second processor comprising a graphics processing unit.

9. The method of claim 1, further comprising subdividing the polygon into a first plurality of subdivided polygons and subdividing a second polygon into a second plurality of subdivided polygons, wherein the first plurality of subdivided polygons is greater than the second plurality of subdivided polygon and the polygon has a higher luminosity metric than the second polygon, and wherein the polygon and the second polygon are of a single object.

10. An apparatus comprising:
a processor to receive geometry data corresponding to a plurality of polygons of a scene to be rendered into a mesh, calculate a luminosity metric and compare the luminosity metric to a predetermined threshold for each polygon, and subdivide the polygon into a plurality of subdivided polygons if the luminosity metric is greater than the predetermined threshold.

11. The apparatus of claim 10, wherein the processor is to prevent subdivision of a polygon if the polygon is in a shadow region of the scene, is back facing, translucent, or hidden behind fog.

12. The apparatus of claim 10, wherein the processor is to dynamically determine a level of subdivision for each of the plurality of polygons greater than the predetermined threshold based on the luminosity metric.

13. The apparatus of claim 10, wherein the processor comprises a graphics processor including a geometry shader, and coupled to a graphics memory, wherein the graphics processor is to store data of the plurality of subdivided polygons in the graphics memory.

14. The apparatus of claim 13, wherein the graphics processor includes a render engine to render the scene using data in the graphics memory.
